(19) United States
(12) Patent Application Publication
(10) Pub. No.: US 2006/0149686 A1
(43) Pub. Date: Jul. 6, 2006

(54) Method of payment and settlement of goods and services via the INTERNET

(76) Inventor: Allison Debonnett, Chicago, IL (US)

Correspondence Address: Allison Debonnett, 47 West Polk. # 100-266, Chicago, IL, 60605, US

(21) Appl. No.: 10/985,744

(22) Filed: Nov. 10, 2004

Related U.S. Application Data
(63) Continuation of application No. 09/727,050, filed on Nov. 30, 2000, now abandoned.

(51) Int. Cl. G06Q 99/00

(52) U.S. Cl. 705/79; 705/78

(57) ABSTRACT

This invention relates to a specific method and process of payment and settlement of goods and services purchased through an INTERNET network platform. The method enables seamless connectivity between INTERNET purchaser/buyer savings, checking, money market, certificate of deposit and cash management account and merchant/seller savings, checking, money market and cash management account for payment and settlement of goods or services purchased over the INTERNET platform.

### FIELD OF INVENTION

This invention relates to a specific method and process of payment and settlement of goods and services purchased through an INTERNET network platform. This invention is a continuation of a provisional application No. 60\168,888 filed on Dec. 3, 1999 and non-provisional application No. 09\727,050 filed on Nov. 30, 2000. The method enables seamless connectivity between INTERNET purchaser/buyer savings, checking, money market, certificate of deposit and cash management account and merchant/seller savings, checking, money market and cash management account for payment and settlement of goods or services purchased over the INTERNET platform.

### BACKGROUND OF INVENTION

Despite the present use of traditional currency, credit cards, debit/smart cards and hybrid Internet payment systems developed by DigiCash and CyberCash, the current market lacks direct seamless connectivity between the various internet devices and demand deposit accounts. Predominately, most on-line vendors require customers to enter financial data such as credit card and mailing information for transaction payment, settlement and delivery. The vendor then stores this information to be used in later transactions with the same customer. In normal transactions, the time it takes for a customer to enter this information inhibits the efficient use of e-commerce opportunities. Though INTERNET credit card clearing facilities exist, many consumers are reluctant to transmit financial information (including credit card, banking, residence, etc.) electronically without the verification that it is secure.

Additionally, eWallets have been developed to provide third party data storage allowing access to personal information by merchants and other consumers. We have composed a system that enables seamless online commercial/investment bank account access by means of a universal DDA/CMA account connectivity/interface, called CyberMoney™ where customers would utilize the CyberMoney™ interface for accessing established checking, savings, or cash management accounts to pay for goods and services purchased, viewed or delivered via the INTERNET. Furthermore, as this system becomes accepted in the marketplace, clients will seek to utilize currency exchange/conversion exclusively via a cyber-exchange functionality which, allow customers to convert world currency account values dynamically.

### BRIEF SUMMARY OF INVENTION

The present invention is to a business method for Internet transaction payments. A solution for direct and seamless Demand Deposit Account (DDA)/Cash Management Account (CMA) connectivity interface for Business-to-Business (B2B), Business-to-Consumer (B2C) or Business-to-Exchange (B2E) purchases via the INTERNET. We prescribe a new standard of “INTERNET Payment Solutions”, enabling the global transfer and exchange of stored forms of value. This network system will not be predicated on credit nor debit card clearing. This system of seamless integration will allow private branding, differentiation of services, cooperation and standardization of payment between financial institutional syndicate members and INTERNET merchants. The syndicate of financial channel members shall share in saving substantial operational cost by foregoing the cost of deploying various proprietary and non-standardized payment facilities. Accordingly the total aggregate cost to generate and reconcile a typical off-line payment invoice amounts to $75 as opposed to the cost of generating online payment solutions at $0.50 to $0.90 per transaction. By lowering financial channel partners and merchant transaction costs, CyberMoney payment solutions will encourage the continued growth and development of the global INTERNET economy.

Other features and advantages of the present invention will be apparent from the following description in which the preferred embodiments have been set forth in conjunction with the accompanying drawings.

### BRIEF DESCRIPTION OF VIEWS OF DRAWINGS

In describing the preferred embodiments of the invention reference will be made to the series of figures and drawings briefly described below.

FIG. 1 shows a flowchart of the consumer/merchant enrollment method.

FIG. 2 illustrates the network payment and settlement process.

FIG. 3 illustrates the network architecture and server topology.

FIG. 4 illustrates the methods interaction between the various accounts.

FIG. 5 illustrates the various INTERNET connectivity mediums.

FIG. 6 illustrates the methods interaction between the hardware components of the variouis financial systems.

FIG. 7 illustrates the methods interaction between the financial channel market members.

There may be additional structures described in the foregoing application which are not depicted on one of the described drawings. In the event such a structure is described but not depicted in a drawing, the absence of such a drawing should not be considered as an omission of such design from the specification.

### DETAILED DESCRIPTION OF THE INVENTION

The present invention is to a business method for Internet transaction payments. A solution for direct and seamless Demand Deposit Account (DDA)/Cash Management Account (CMA) connectivity interface for Business-to-Business (B2B), Business-to-Consumer (B2C) or Business-to-Exchange (B2E) purchases via the INTERNET.

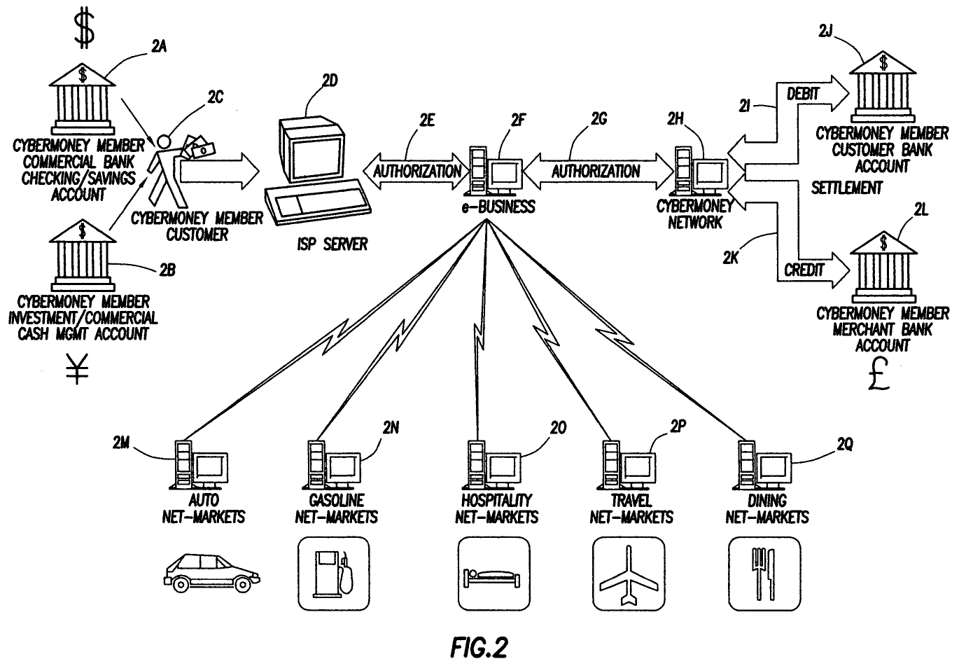

Referring to FIG. 2, is the network provides an agnostic universal front-end and connectivity interface for commercial and investment bank accounts. A typical network customer is enrolled in the Cybermoney network. In a typical transaction, the customer 2C, is empowered with an established commercial bank checking or savings account 2A, or commercial bank/investment bank cash management account 2B. The customer 2C connects to INTERNET via wireless device or an INTERNET SERVICE PROVIDER (ISP) 2D, the user proceeds to purchase goods or services from an eBusiness 2F. Additionally, the customer 2C may select goods and services from a brick and mortar merchant. Once a selection is made by the customer 2C, the customer 2C using the wireless device initiates the Cybermoney network connectivity. In both instances, an authorization 2E and authentication query 2G, is made to the network secure server 2H. If the customer identity is authenticated 2G and customer account 2J, balance is sufficient, successful transaction authorization 2E, is transmitted to customer 2C and merchant 2F.

According to back-office settlement procedures, customer 2C account reconciliation and settlement occurs whereby customer Bank and money market accounts 2J is debited and merchant accounts 2L is credited. Examples of various web merchants or exchange markets are automobile 2M, gasoline 2N, hotel and hospitality 2O, travel 2P, and dining 2Q.

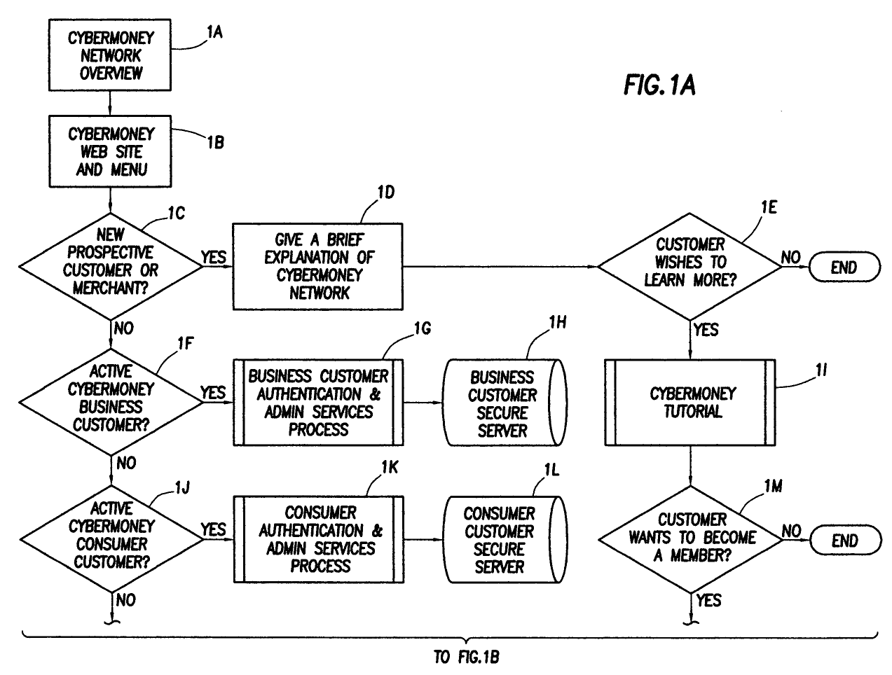

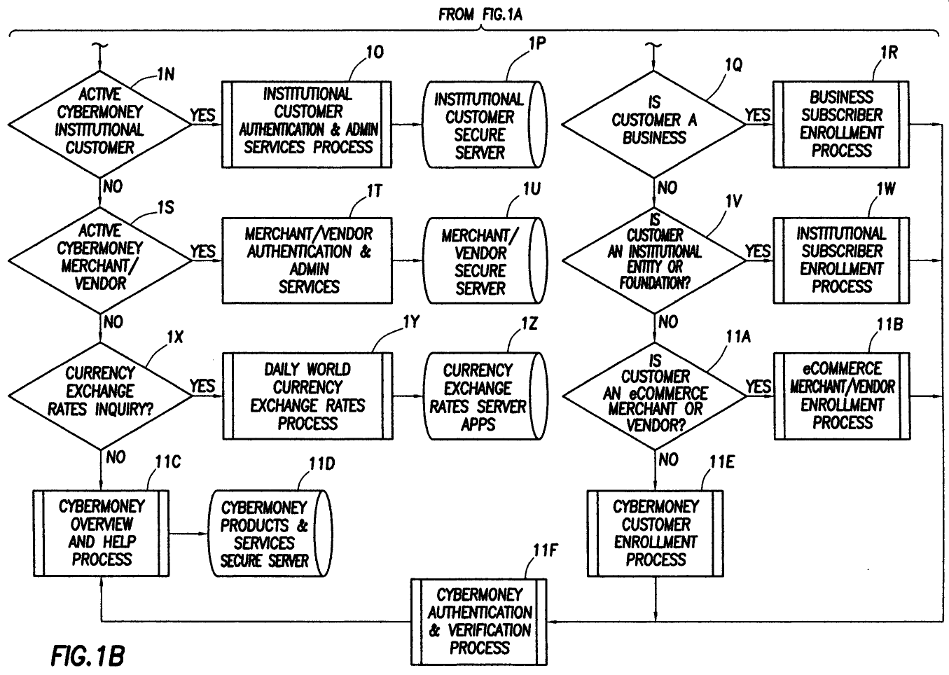

As shown in FIG. 1, the method of enrollment is comprised of web site interaction logic for consumer and network users. These can be defined as individual consumers, merchant consumers, institutional consumer, and merchant vendors. The consumers or merchant vendor users accesses the internet at 1A, and begins the process by which a user comes to the web site for direct interaction with network services. Upon viewing the initial user menu 1B, the user has the option of selecting service as a new user either consumer or merchant vendor 1C. If the user is new merchant or consumer, user is directed to learning Cybermoney network 1D through 1M. The new user then begins the subscription process 1Q, 1R, 1V, 1W, 11A, 11B, 11E, and 11F. Upon completion the user is directed to customer authentication 11F. The user is then directed to the cybermoney network and product overview 11C via the secure server 11D.

Dependent upon the user access to products and services flows through the secure server at 1H, 1L, 1P, and 1U. Then allows the user to begin the cybermoney network subscription services as shown at 2H. The customer also has an initial option of viewing current currency exchange rates 1X. Otherwise, the user has the option to select help for navigating the site 11C and can be granted access to a list of product, services, banks and merchants members of the network 11D.

The primary focus and function of the network is to provide an agnostic universal front-end and connectivity interface for commercial and investment bank accounts. This process is illustrated by an overview of the payment and settlement data flow as follows.

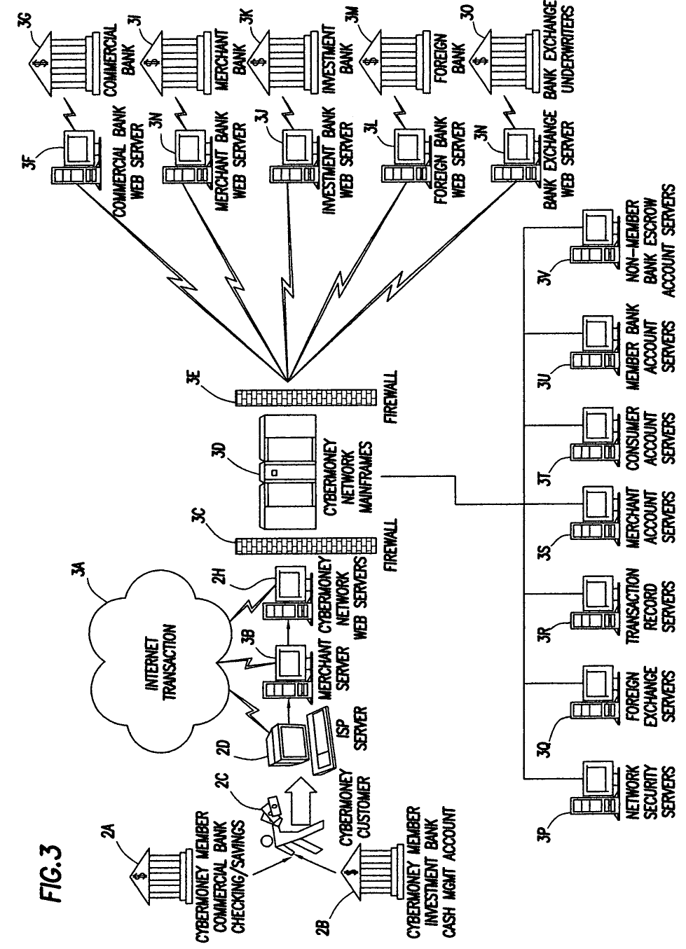

As shown in FIG. 3, the network architecture and topology are central to the implementation of this invention, specific network integration components give clarity to connectivity architecture. As the network customer 2C connects to the INTERNET via an ISP server 2D and engages in a INTERNET transaction 3A, for the purchase of goods or services from a web merchant via the merchant server 3B, the merchant server 3B communicates to the seamless network web server 2H and evokes transaction authorization and customer authentication. The seamless network web server facilitates connection to the network mainframe host computer 3D after analysis of transaction security parameters via a intranet firewall 3C.

The network security server 3P sends a query to customer 2C for customer identification. Based upon customer response, network security server 3P checks for customer membership demographics and authentication methodology such as biometric or password authentication processing. The network security server 3P sends the customer a request for the necessary authentication method entry.

If authentication is successful, the merchant account server 3S or the consumer account server 3T is checked for the adequacy of account balance to cover transaction purchase. If authentication is not successful, a message is sent to customer 2C, requesting verification and re-entry. This is done no more than two or three times, based upon security parameters. Predicated on account balance and dynamic credit analysis procedures stored in member bank servers 3U, providing the funding of commercial bank account 2A or investment bank account 2B, successful transaction authorization is sent to customer 2C and merchant server 3B. The transaction is then logged in the transaction record server 3R database. Merchant account server 3S, consumer account server 3T and member bank account server 3U do not store account values due to strict federal banking regulations. They only contain bank account access protocols based upon the INTERNET enabled device initiating transaction.

The settlement and reconciliation process involves the back-office processing procedures whereby member bank servers 3T contains member bank reconciliation and settlement process procedures. If for any reason a verified and credit-worthy bank/merchant customer 2C is involved in a transaction without an active network commercial bank 2A or investment bank 2B account, reconciliation and settlement will be made through strict processing procedures contained in the non-member bank escrow account server 3V.

Daily updates to member bank account server 3U data and account information is processed through an exclusive firewall protected 3E, virtual private network (VPN) interface to a network of commercial bank web servers 3F, merchant bank web servers 3H, investment bank web servers 3J, foreign commercial bank web servers 3L and collective bank clearinghouse web servers 3N.

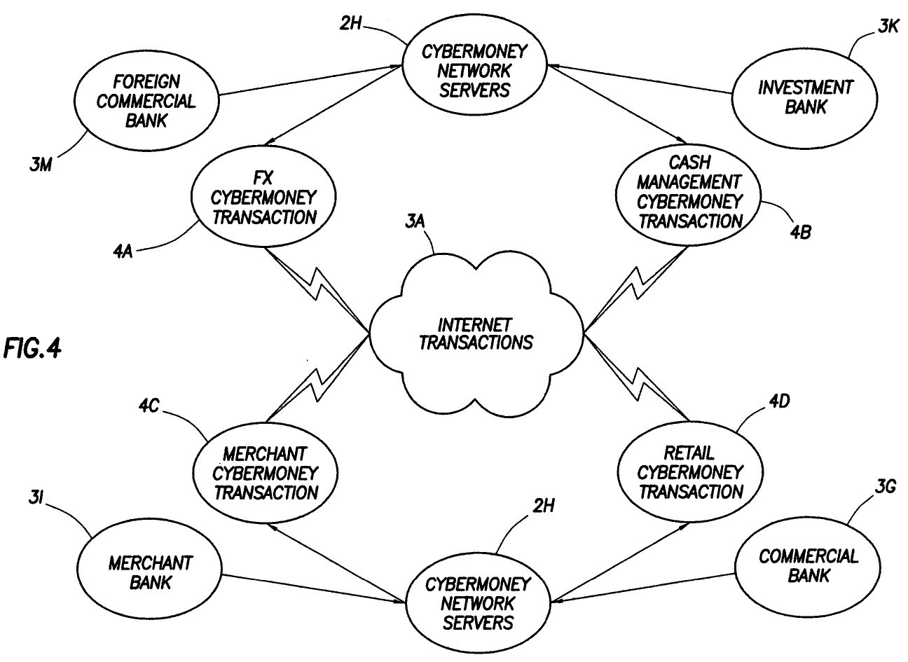

FIG. 4 provides detail illustration of the internal interaction between the various bank accounts and the seamless network account interface of Cybermoney. With respect to an INTERNET transaction 3A, the seamless network server 2H provides a universal front-end for empowering an investment bank 3k, or member bank cash management network account transactions 4A-D.

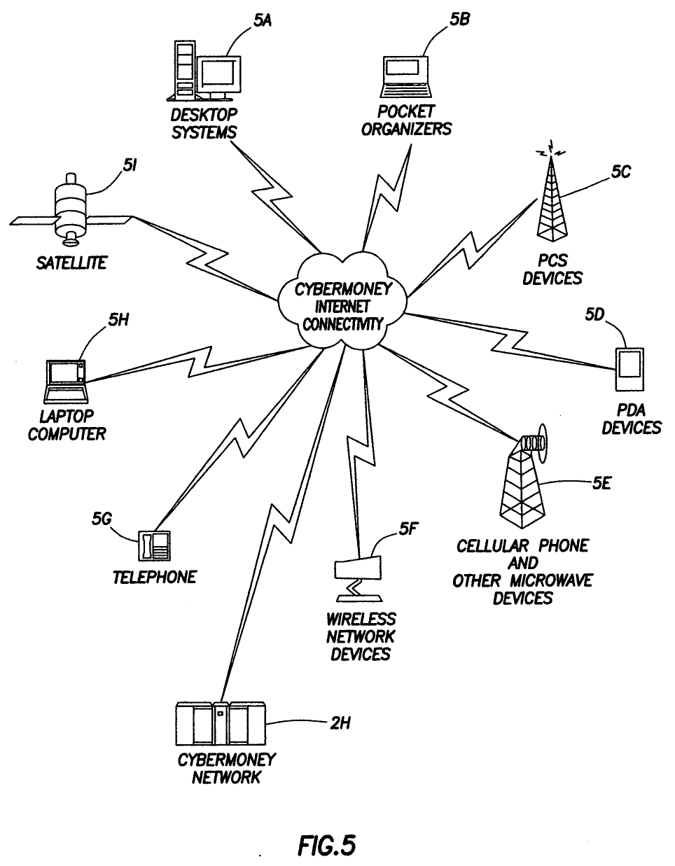

FIG. 5 illustrates the various INTERNET connectivity mediums in which the network can be accessed. This seamless network platform 2H and all of its application programming interface constructs are device agnostic. As a result, the network enables multiple INTERNET connectivity mediums such as: web-enabled desktop systems 5A; pocket organizers 5B; personal communication systems devices (PCS) 5C; personal digital assistants (PDAs) 5D; cellular and microwave based devices 5E; wireless devices 5F; digital phones 5G; laptop computers 5H and satellite based communication devices 5I.

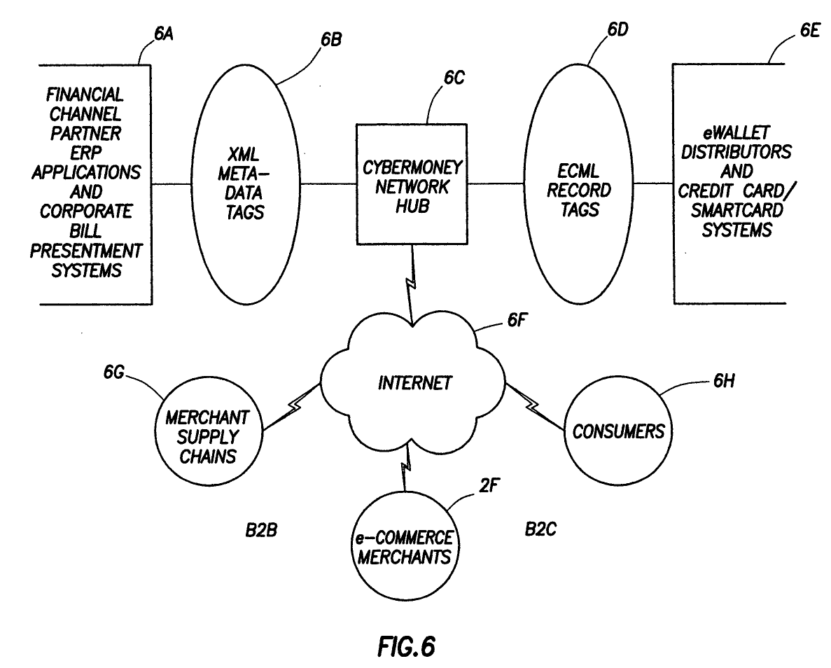

FIG. 6 denotes the application architecture of the network application programming interface components. The network applications interface embraces open-end architecture for robust network compatibility across a broad spectrum of different computer systems and hardware. The front-end web site graphical user interface incorporates the latest convention of hypertext markup language called “Extended Markup Language,” or XML meta-data tags 6B. This enables compatibility with commercial and investment bank computer systems that have existing enterprise resource planning (ERP) and bill presentment system solutions 6A.

In an effort to ensure compatibility with all commercially available eWallet 6E constructs and systems, the network adheres to universal standards for wallets and merchant web sites set forth in a format know as Electronic Commerce Modeling Language (ECML) tags 6D. ECML uses a set of uniform field names that streamlines the process by which merchants collect electronic data for shipping, billing and payment. Our seamless network architecture includes an agnostic eWallet interface for universal wallet compatibility, providing seamless INTERNET connectivity integration.

The seamless network topology enhances the customer experience within business-to-business transactions between merchant supply chains 6G and web merchants 2F, as well as business-to-consumer transactions between web merchants 2F and consumers 6H.

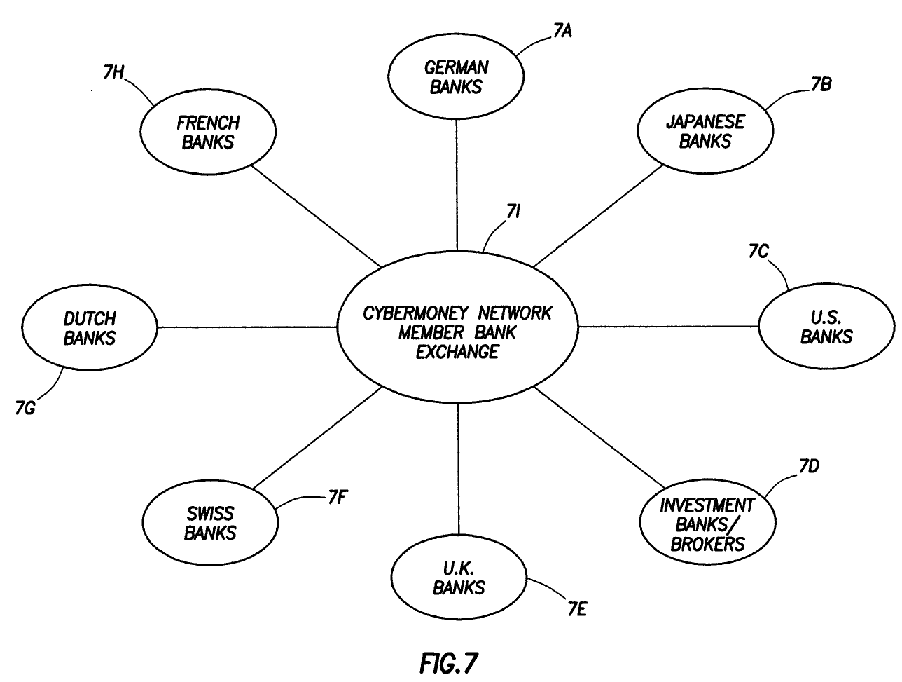

FIG. 7 represents the global member banking syndication method for distributing network connectivity. The comprehensive strategy and unique focus of seamless network connectivity is best implemented through a truly global architecture as illustrated by FIG. 7. Optimum initial network server market venues are graphically depicted. These include: German banking market 7A, the Japanese banking market 7B, the U.S. banking market 7C, the global investment banking/brokerage market 7D, the United Kingdom banking markets 7E, the Swiss banking markets 7F, the Dutch/European banking markets 7G and the French banking markets 7H. The methodology of global INTERNET bank account syndication 7I, culminates into an efficient exchange of global and seamless INTERNET financial payment and settlement.

Further modification and variation can be made to the disclosed embodiments without departing from the subject and spirit of the invention as defined in the following claims. Such modifications and variations, as included within the scope of these claims, are meant to be considered part of the invention as described.

1. A method of enabling payment and settlement of goods and services said method comprising the steps of:
a) receiving a request from a user for a settlement of a transaction, verification of a user account and authentication of said user;
b) receiving a request for payment from a vendor, verification of said vendor account and authentication of said vendor;
c) sending a request for debit to a user third party account, and a request for credit to a vendor third party account;
d) receiving a confirmation of debit from said user third party account, and receiving a confirmation of credit from said third party account; and
e) sending a confirmation signal to said user, and sending confirmation signal to said vendor.

2. The method as recited in claim 1 further comprising the step of querying the user third party account for account balance and sufficiency of transaction.

3. The method as recited in claim 2 further comprising the step of receiving a response from said query indicating insufficiency of the account and sending a second query to a secondary user third party account for account balance and sufficiency of transaction.

4. The method as recited in claim 2 further comprising the step of receiving a response from said query indicating sufficiency of the account and sending a request to said user third party account for debit.

5. The method as recited in claim 3 further comprising the step of receiving a response from said query indicating sufficiency of the secondary user third party account and sending a confirmation to the user indicating insufficiency of said third party account and sufficiency of said secondary user third party account.

6. The method as recited in claim 5 further comprising the step of receiving a response from said user and receiving a request from said user to debit the user secondary third party account.

7. The method as recited in claim 1 further whereby the method of receiving a request and sending response is via the internet.

8. A method of enabling payment and settlement of goods and services said method comprising the steps of:
a) receiving a request from a vendor to open a new account;
b) sending a response to said vendor and instructing said user in account set up;
c) receiving a response from said vendor designating an account type and linking a third party account;
d) verifying said vendor and said third party account;
e) sending a response to said vendor indicating the establishment of said new account;

9. The method as recited in claim 7 wherein said user is defined as a consumer, vendor, or institutional organization.

10. The method of as recited in claim 7 wherein said set of verifying said user and said third party account further comprises conducting a credit risk analysis.

11. The method as recited in claim 9 wherein said step of establishing said new account further comprises setting a transaction limit based upon the credit risk analysis.

12. The method as recited in claim 7 further whereby the method of receiving a request and sending response is via the internet.

13. The method of paying and settlement of business transactions via internet comprising the steps of:
a) receiving a request from a user to open a new account;
b) sending a response to said user and instructing said user in account set up;
c) receiving a response from said user designating an account type and linking a third party account;
d) verifying said user and said third party account; and
e) sending a response indicating the establishment of said new account;
f) receiving a request for payment from said vendor, verification of said vendor account and authentication of said vendor;
g) sending a request for debit to a user third party account, and a request for credit to a vendor third party account;
h) receiving a confirmation of debit from said user third party account, and receiving a confirmation of credit from said third party account; and
sending a confirmation signal to said user, and sending confirmation signal to said vendor.

14. The method as recited in claim 13 further comprising the step of querying the user third party account for account balance and sufficiency of transaction.

15. The method as recited in claim 14 further comprising the step of receiving a response from said query indicating insufficiency of the account and sending a second query to a secondary user third party account for account balance and sufficiency of transaction.

16. The method as recited in claim 14 further comprising the step of receiving a response from said query indicating sufficiency of the account and sending a request to said user third party account for debit.

17. The method as recited in claim 15 further comprising the step of receiving a response from said query indicating sufficiency of the secondary user third party account and sending a confirmation to the user indicating insufficiency of said third party account and sufficiency of said secondary user third party account.

18. The method as recited in claim 17 further comprising the step of receiving a response from said user and receiving a request from said user to debit the user secondary third party account.
